(19) United States
(12) Patent Application Publication
(10) Pub. No.: US 2009/0038486 A1
(43) Pub. Date: Feb. 12, 2009

(54) Cherry fork

(76) Inventor: Edouardo A. Jordan, Seattle, WA (US)

Correspondence Address: Edouardo Jordan, 2115 16th Street South, St. Petersburg, FL, 33705, US

(21) Appl. No.: 11/834,511

(22) Filed: Aug. 6, 2007

(51) Int. Cl. A47J 23/00

(52) U.S. Cl. 99/564; 99/547

(57) ABSTRACT

A utensil used for removing pits from cherries and similar fruits. A clawed and tunneled utensil used to cleanly remove pits from the bottom of cherries or other similar fruits with a single one-sided hole keeping the stem and fruit intact.

### BACKGROUND OF THE INVENTION

The present invention was created to promote the pure beauty of cherries. Working in the food industry I realized that cherries were abused by pitters that simply destroy the dexterity of the fruit. Once pitted, all cherries looked the same, a round deformed mass with two holes. The idea of this invention came about when I discovered the pit could be removed from the bottom of the fruit while keeping the stem attached to the top of the fruit (the fruit in its natural state). This presentable fruit was great for looks and allowed the fruit to be served in various forms, other than the typical cherry pie, cherry tarts, cobblers and other stem off recipes. This new option allows for new creations and a very beautiful, flawless fruit.

1. Field of the Invention

This invention is related to other devices or machines used to remove pits, seeds or stones from cherries and other related fruits, and more particularly an apparatus that is hand-held. By way of example: U.S. Pat. No. Des. 330,833 to Cheung discloses the design of a cherry pitter. U.S. Pat. No. Des. 317,107 to Grass discloses the design of a cherry pitter or similar article. U.S. Pat. No. 5,437,225.

2. Description of the Prior Art

There are several types of hand-held cherry pitter devices available. These prior pitters and stone removals typically creates two holes in the fruit from top to bottom when extracting the stone/pit/seed (example: U.S. Pat. No. D330,833; 1992 Cheung); however, it is the objective of the present invention to produce a single one-sided hole where the stone is removed from the bottom hole keeping the stem and cherry intact.

### SUMMARY OF INVENTION

The Cherry Fork pitter is designed to remove pits, stones, and/or seeds from cherries and similar fruits while keeping the integrity and stem of the fruit intact.

### DETAILED DESCRIPTION OF THE INVENTION

The Cherry Fork pitter of the present invention comprises an extended shaft attaching the forking prongs “claws” and a circular cutter “tunneler”. The fork-prongs consist of two or more “U” shaped curving claws mounted to the shaft. The curvature of the prongs is designed to grip and lock to the stone for unproblematic dislodging from the fruit. This shape is found to cause minimal damage to the outer flesh and inner core during removal. On the opposite end of the utensil is a circular shaped cutter, the tunneler. The tunneler creates the initial puncture in the bottom of the fruit by cutting a small circle the same diameter of the claw end of the utensil. Once the fruit is cut and the pits/stones/seeds have been found, the claws are inserted in the punctured bottom to dislodge the pit. Cherries and similar fruits vary in size, therefore the convenient small shape of the cutter and claws enable maximize fruit yield.

When inserting the Cherry Fork correctly, the tunneler will puncture the outer bottom flesh of the cherry or similar fruit, creating a clean circular cut of the fruit. The tunneler is thereafter turned in a circular motion to loosen the stone from the inner core of the fruit. The prong side of the utensil is then inserted into the fruit; thereafter, the claws are gently angled and slid along the side of the stone until the claws reach the top of the stone. The Cherry Fork is then pressed tightly against the top of the pit to grip the stone. The stone is gently dislodged from the fruit directly through the initial puncture. Cherries or similar fruits thereafter can be cooked, marinated, and or served raw as if they have never been touched. The fruit when placed on a flat surface will resemble an untouched cherry directly from the tree.

### BRIEF DESCRIPTION OF THE SEVERAL VIEWS OF THE DRAWING

FIG. 1 is a perspective view of a Cherry Fork according to the invention.

FIG. 2 is a view of the tunneler

FIG. 3 is a view of the claws

FIG. 4 is a view of the entire side view

FIG. 5 is a perspective view of the Cherry Fork in use

FIG. 6 is a view of the blade guard

### DETAILED DESCRIPTION OF THE DRAWINGS

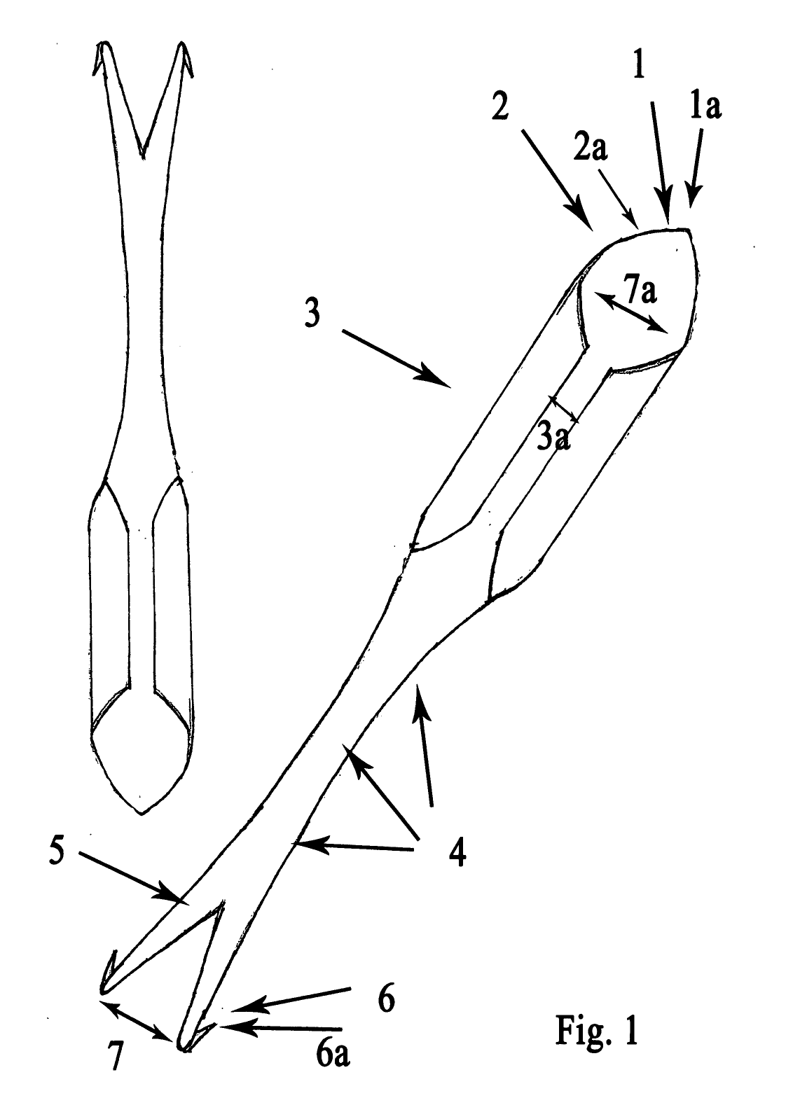

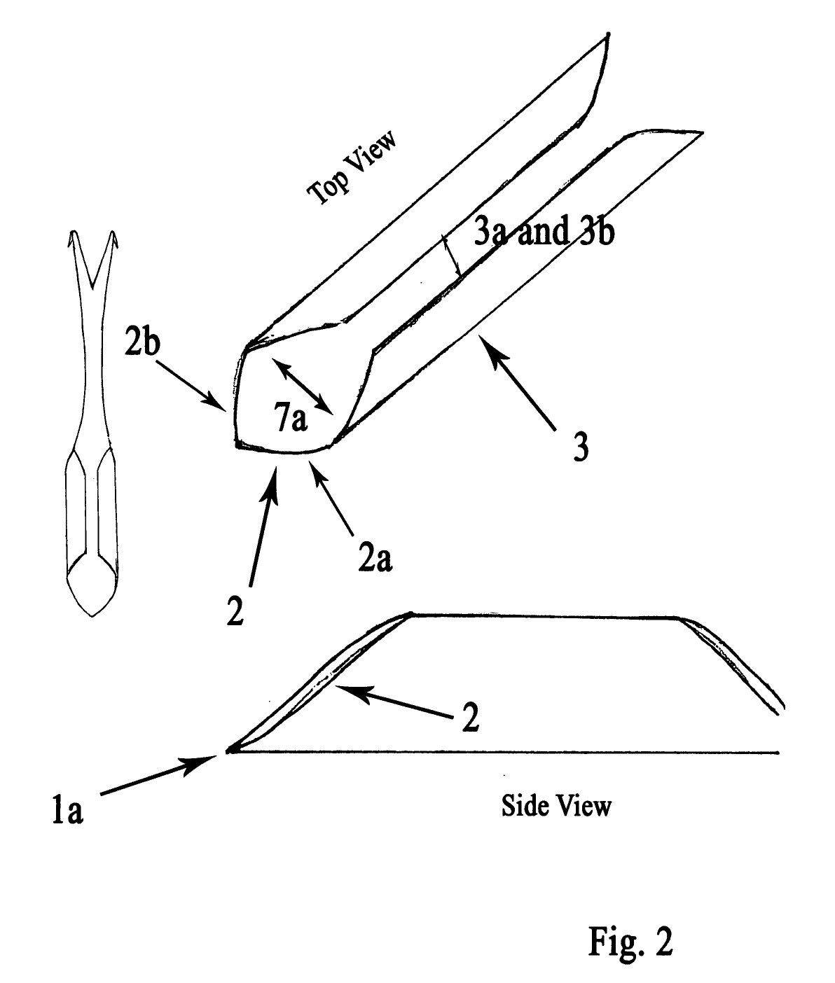

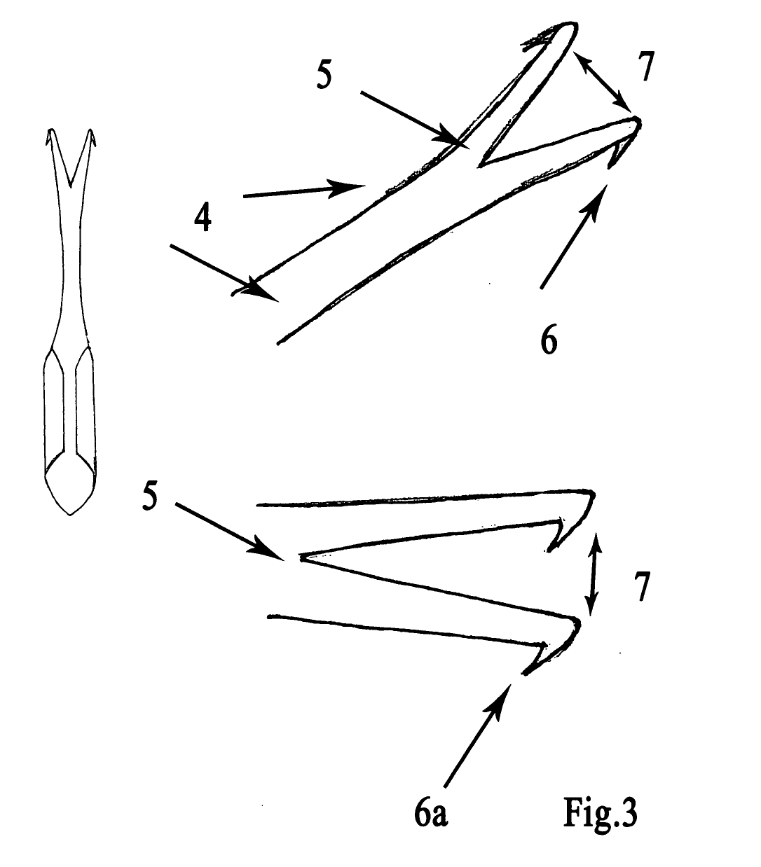

FIG. 1 is a perspective view of the Cherry Fork according to its intended use. The Cherry Fork includes a tunneler end (3) and a claw end (6) attached by a shaft (4). Starting with the tunneler portion of the utensil FIG. 2 (3), the tunneler is constructed into a “U” shaped cutter (2) which consist of two sharpen edges (2a & 2b). The tunneler's sides (2a & 2b) are angled, creating a slight point (1) where the two sides (2a & 2b) meet at the bottom (1). 7a displayed in FIG. 3 displays the diameter of the fork which also matches the diameter between the two claws (6) and (7). Moving back from the starting point of the tunneler FIG. 2 (1), two top flaps are shown (3a & 3b). These flaps are constructed for manual adjustment of the size of the tunneler (3) and gripping when in use. This adjustment can be made by squeezing the sides of the tunneler (3) decreasing the gap between the sides (3a). This feature is useful for removal of seeds of smaller fruits (tart cherries, sour cherries, or pie cherries). Once the sides have been comprised the tunneler can be resized to its original state by expanding the gap between the sides (3a & 3b).

In FIG. 1, the shaft (4) is shown attaching the tunneler to the claw end of the utensil. The shaft (4) is constructed of the same material as both ends. The shaft rounds into a tube like structure from the tunneler (3), penciling out to the claws (6). It should be noted that the tubular form of the shaft illustrated should not dictate or limit the laws governing the patent, as the Cherry Fork's shaft could be flat, squared, circular or decorative. The shaft is created specifically as a connector, binding the two ends together.

Moving further down the shaft FIG. 3 (4) the fork begins to split in a “V” shaped fashion (the fork in the utensil) (5) which attach the claws (6). The “V” (5) attaching the claws expands in diameter until it reaches the specified diameter (7). Each end of the “V” shape (5) is then curved into a claw-like hook (6). Each hook is honed at its end (6a) creating a needle point for easy snagging of pits or seeds. The curvature of the hooks is limited to a small bend enabling minimal damage to the fruit.

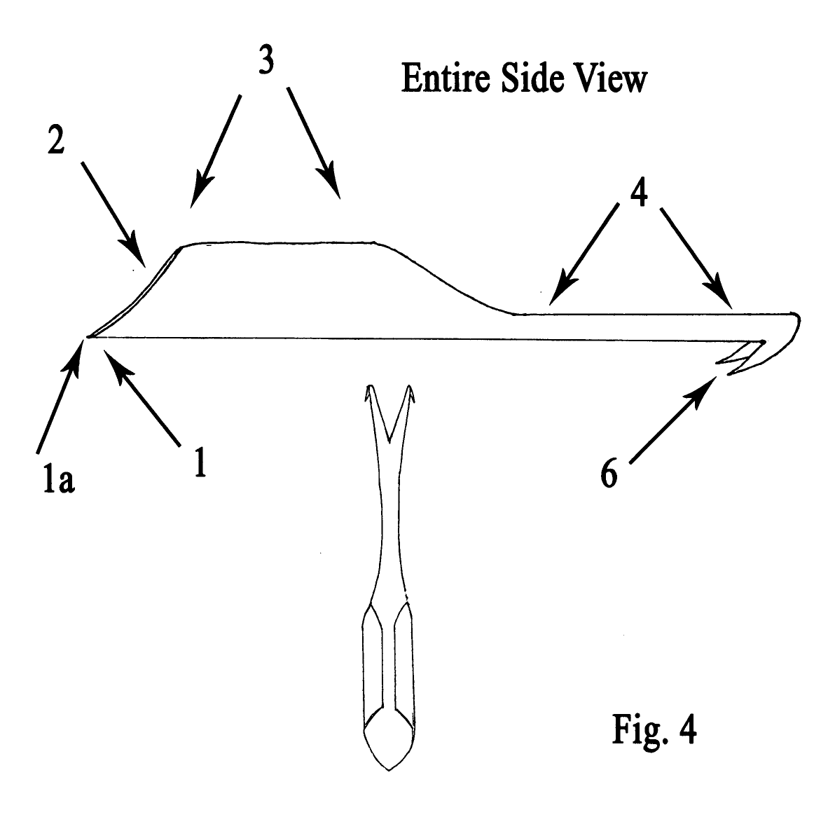

FIG. 4, displays an entire view of the Cherry Fork from its side. Note the areas of interest: tunneler (3), shaft (4), and claws (6).

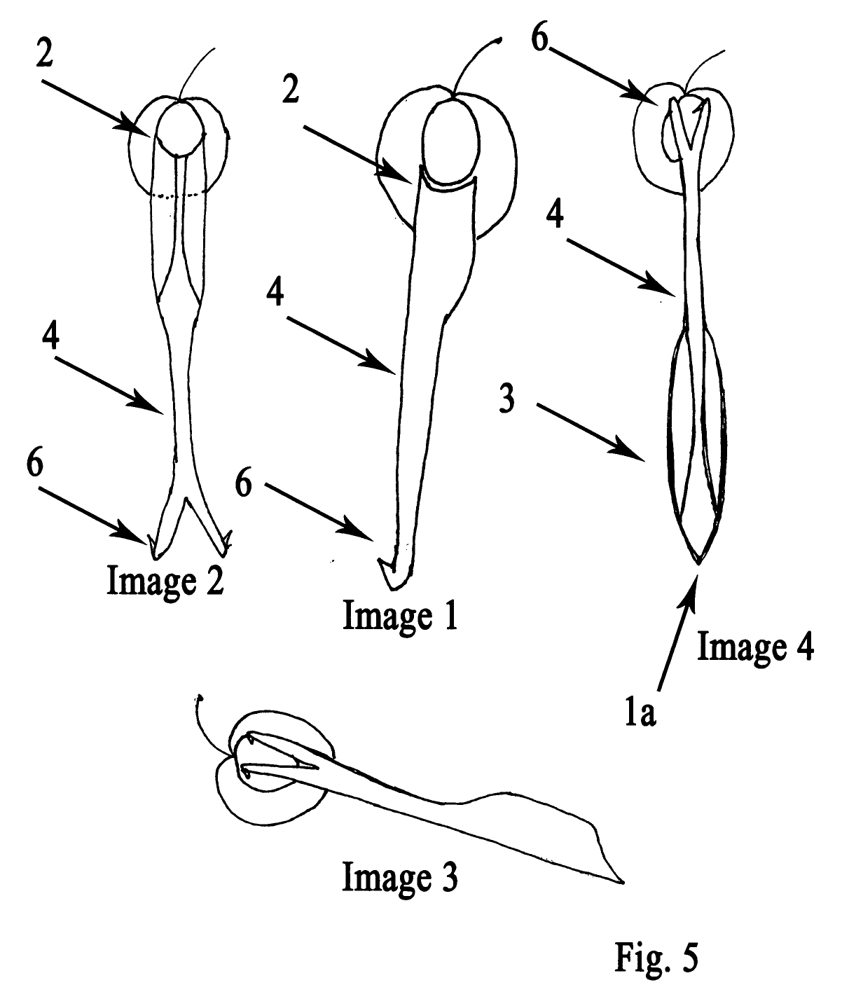

FIG. 5 demonstrates the Cherry Fork in use. Image 1 & 2 shows the tunneler puncturing the fruit and reaching the pit. Image 3 & 4 shows the claws before extraction of pit.

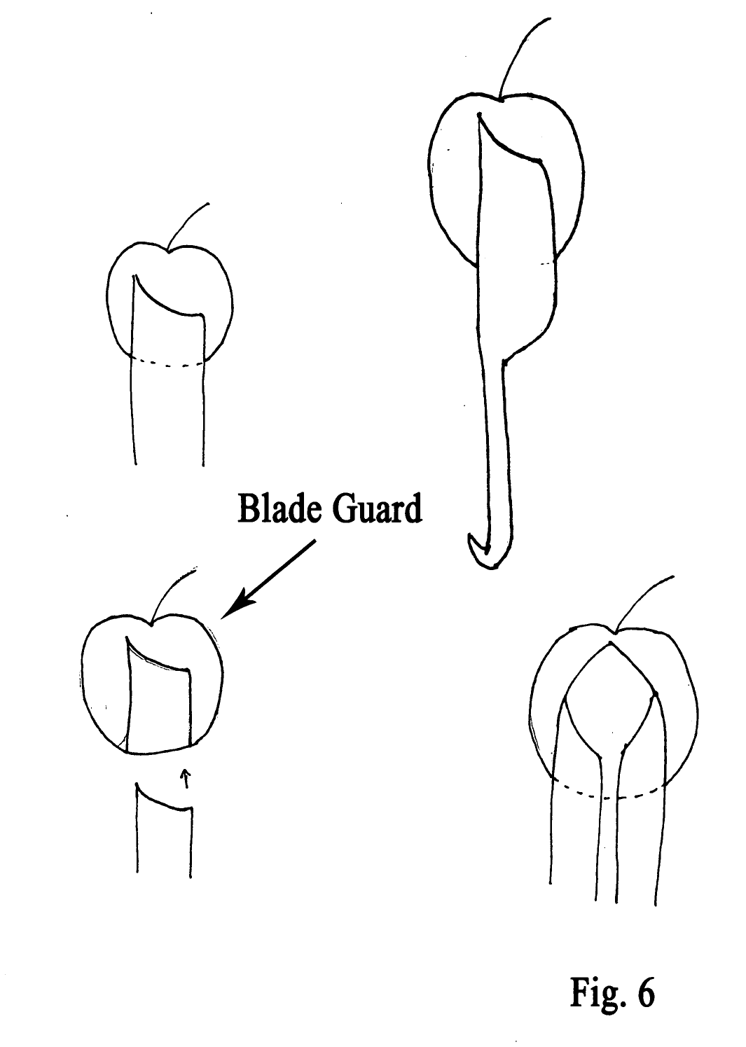

FIG. 6 displays a sample of the blade guard used to cover and protect the tunneler side of the utensil when not in use.

This patent should not be limited to a specific design or shape, as the invention can be embodied in other specific forms without departing from the spirit or essential attributes thereof; reference should be made to the following claims, rather than to the foregoing specification, as indicating the scope of the invention.

1. The present device is a pitter designed for hand-held removal of cherry pits or pits from similar related fruits. This said utensil creates a single-sided hole in the bottom of the fruit which does not disturb the esthetics of the fruit allowing for a clean presentable fruit with the stem intact.

2. A device according to claim 1 wherein is a pitter, referenced as a Cherry Fork, is structured in the form of a two-sided utensil. The Cherry Fork is designed to remove pits from cherries or other related fruits by tunneling a small hole in the bottom of the fruit; thereafter, removing the pits with its claws through the initial single hole.

3. The Cherry Fork of claim 2 contains two parallel ends, noted as the claw and the tunneler and a middle junction noted as the shaft connecting the ends.

4. The Cherry Fork of claim 2 wherein contains a tunneler or circular cutter used to initiate a clean hole in the base of a cherry or similar related fruit. The tunneler is a “U” shaped circular cutter. The tunneler's circumference is approximately the size of the average stone/pit/seed in cherries and matches the diameter of the claw end of the utensil

5. The Cherry Fork of claim 4 wherein the tunneler when puncturing the fruit will have a hole large enough to insert the opposing parallel end, the claws, of utensil without damaging the fruit's dexterity.

6. The Cherry Fork of claim 4 consist of sharpen edges on the cutting end, giving the tunneler a slight beveled knife-like blade.

7. The Cherry Fork of claim 6 said beveled-sharpen edges decrease in cutting ability as edges move towards opposite end of the utensil.

8. The Cherry Fork of claim 7 consists of two-sided folding flaps connected to the decreasing beveled tunneler's edges. The two-sided flaps act as a wall or tunnel moving away from the tunneler's sharpen-beveled edges.

9. The Cherry Fork of claim 2 contains walls connecting the tunneler to the shaft. These walls are used for gripping when holding the utensil.

10. The Cherry Fork of claim 9 wherein two-sided folding area, noted as walls, are use for adjusting the diameter of the cutter by comprising the gap between the walls, decreasing the diameter of the tunneler. The walls can be readjusted by expanding the gap between the walls, increase the diameter of the tunneler to its original size or larger.

11. The Cherry Fork of claim 2 contains a blade guard. The blade guard protects and covers the cutting end of the utensil when not in use.

12. The Cherry Fork of claim 4 wherein the cutter, referenced as tunneler, is connected to the folding flaps, walls, which are mounted to the shaft, creating the first half of the utensil.

13. The Cherry Fork of claim 2 contains a solid mass, referenced as a shaft, connecting the two ends of the utensil.

14. The Cherry Fork of claim 2 wherein contains at least two or more forking hooks referenced as claws.

15. The Cherry Fork of claim 14 wherein said contains at least two curving fork-like prongs serving as claws, each claw is honed to a point to enable snagging of the stone/pit/seed during removal. Once gripped the seeds are removed through the initial tunneled hole.

16. The Cherry Fork of claim 14 wherein claws are mounted in a “U” or “V” structure creating a split or forking appearance from the shaft.

17. The Cherry Fork of claim 14 wherein claws, is connected to the forking shaft, creating the second half of the utensil.

18. The Cherry Fork of claim 2 wherein is comprised of a thin semi-flexible material, selected from a group of non-corrosive, food grade, material consisting of plastics, stainless steel, aluminum, aluminum alloys, steel alloys, and/or a combination of said materials.
